(19) United States
(12) Patent Application Publication
(10) Pub. No.: US 2004/0141206 A1
(43) Pub. Date: Jul. 22, 2004

(54) Printer to print out motion picture data and a control method thereof

(76) Inventor: Dae-hyun Kim, Seoul (KR)

Correspondence Address: STANZIONE & KIM, LLP, 1740 N STREET, N.W., FIRST FLOOR, WASHINGTON, DC, 20036, US

(21) Appl. No.: 10/714,910

(22) Filed: Nov. 18, 2003

(30) Foreign Application Priority Data
Jan. 16, 2003 (KR) 2003-3134

(51) Int. Cl. G06F 15/00; G06F 3/12

(52) U.S. Cl. 358/1.17

(57) ABSTRACT

A printer printing out motion picture data and a control method thereof include a print engine unit to print data to be printed, an interface unit connected with an external device to receive frames that are successively input from the external device according to the motion picture data, an image extracting unit to extract at least one key frame from the frames inputted through the interface unit, the key frame representing the motion picture data, an image processor to convert data corresponding to the key frame extracted by the image extracting unit into image data that can be printed in the print engine unit, and a controller, upon determining that the motion picture data is received through the interface unit, to control the image extracting unit to extract the at least one key frame to represent the motion picture data, and when the key frame data is converted into the image data by the image processor, the controller controlling the print engine unit to perform a printing operation with respect to the image data. Accordingly, certain motion picture data can be automatically extracted from the motion picture data and printed out on a printing paper.

### CROSS-REFERENCE TO RELATED APPLICATIONS

This application claims the benefit of Korean Patent Application No. 2003-3134, filed Jan. 16, 2003, in the Korean Intellectual Property Office, the disclosure of which is incorporated herein by reference.

### BACKGROUND OF THE INVENTION

1. Field of the Invention

The present invention relates to a printer to print out motion picture data and a control method thereof, and more particularly, to a printer which automatically extracts predetermined frame data from motion picture data transmitted from an external device and prints out the extracted frame data, and a control method thereof.

2. Description of the Related Art

Generally, a motion picture photographing apparatus, such as a digital video camera (DVC), records or reproduces images and sounds captured by a user onto or from a recording medium such as a magnetic tape which is usually inserted in a DVC deck. The images and sounds recorded on the magnetic tape are outputted through a viewfinder thereof or through a speaker. If the motion picture photographing apparatus is connected with displays, such as televisions, the recorded images and sounds of the magnetic tape may also be outputted through the displays.

Motion pictures taken by the user using the motion picture photographing apparatus may also be downloaded onto a computer, edited, and further sent to a printer to be printed out. These days, an increasing number of users want to print out not only data captured by the motion picture photographing apparatus but also movie or animation data obtained from the Internet.

In order to print out motion picture data of the photographic apparatus through the printer, the motion picture photographic apparatus needs to be connected with the computer so that desired frames among successive frames of the motion picture data can be captured by a capture program that is installed in the computer. The captured frames are converted into image data by a printer driver stored in a memory of the computer and sent to the printer. As a result, the image data from the computer are printed out by the printer.

As described above, among the frames of the motion picture data, only predetermined selections of frames can be captured and printed out using external equipment such as a computer having the capture program installed therein. However, the requirement that the printer has to be connected to the external equipment installed with the capture program and the printer driver is somewhat cumbersome. Furthermore, it is difficult to capture the motion picture data, which have 15 to 30 frames per second, frame by frame.

### SUMMARY OF THE INVENTION

In order to solve the above and/or other problems, it is an aspect of the present invention to provide a printer capable of automatically extracting key frames among incoming frames of motion picture data from a motion picture providing apparatus, and printing out the extracted key frames that represent the inputted motion picture data, and a control method thereof.

Additional aspects and advantages of the invention will be set forth in part in the description which follows and, in part, will be obvious from the description, or may be learned by practice of the invention.

In order to achieve the above and/or other aspects of the present invention, there is provided a printer capable of outputting motion picture data. The printer includes an interface unit provided to be connected with an external device to receive frames that are successively input from the external device according to the motion picture data, an image extracting unit to extract at least one key frame among the frames inputted through the interface unit, the key frame representing the motion picture data, and a controller, upon determining that the motion picture data is received through the interface unit, to control the image extracting unit to extract the at least one key frame to represent the motion picture data.

According to another aspect of the present invention, the printer further includes a print engine unit to print data to be printed, and an image processor to convert key frame data corresponding to the key frame extracted by the image extracting unit into image data that can be printed in the print engine unit.

The image extracting unit compares a current frame that is input through the interface unit with a reference frame, calculates a comparison result, compares the comparison result with a predetermined threshold value, and extracts the current frame as the key frame that represents the motion picture data when the comparison result is greater than the predetermined threshold value.

The reference frame is at least one of a preceding frame of the current frame and a preceding key frame that is extracted previously.

In order to achieve the above and/or other aspects of the present invention, there is provided a control method used with a printer capable of outputting motion picture data. In the printer connected with an external device through an interface unit and printing out the motion picture data input from the external device, the control method includes receiving data from the external device through the interface unit, determining whether the data to be printed received through the interface unit is the motion picture data, extracting a key frame among the frames that are successively input according to the motion picture data, the key frame that represents the motion picture data when it is determined that the data is the motion picture data, converting the extracted key frame data into image data, and printing out the converted image data on a printing paper.

In an aspect of the present invention, the extracting of the key frame includes comparing a current frame of the motion picture data, which is input through the interface unit, with a reference frame, thereby calculating a comparison result, comparing the comparison result with a predetermined threshold value, and extracting the current frame as the key frame, that represents the motion picture data, when the comparison result is greater than the predetermined threshold value.

In another aspect of the present invention, the reference frame is at least one of a preceding frame of the current frame and a preceding key frame that has been extracted previously.

### BRIEF DESCRIPTION OF THE DRAWINGS

These and/or other aspects and advantages of the present invention will become apparent and more readily appreciated from the following description of the embodiments, taken in conjunction with the accompanying drawings of which:

FIG. 1 is a block diagram illustrating an image printing system having a printer with a motion picture printing print-out function according to an embodiment of the present invention;

FIG. 2 is a flowchart illustrating a control method used with the printer of FIG. 1 according to another embodiment of the present invention; and

FIG. 3 is a flowchart illustrating a key frame extracting process of the control method illustrated in FIG. 2.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below in order to explain the present invention by referring to the figures.

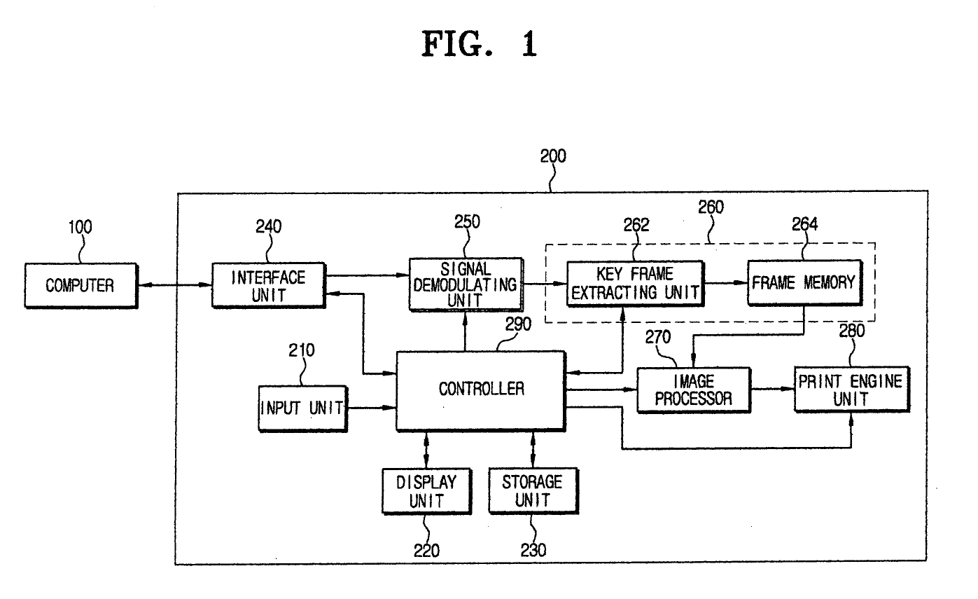

FIG. 1 is a block diagram illustrating an image printing system having a motion picture printout function according to an embodiment of the present invention.

Referring to FIG. 1, the image printing system includes a computer 100 as a motion picture provider, and a printer 200 as a motion picture output (providing) apparatus. Among various motion picture providing apparatuses, the computer 100 and the printer 200 connected to the computer 100 will be taken as an example of the image printing system in the following description of the embodiment of FIG. 1.

The computer 100 is an external apparatus that transmits signals of a motion picture, such as movies or animations, to the printer 200.

Another example of the external apparatus connected to the printer 200 includes a digital video camera, a personal digital assistant (PDA), and a cellular phone.

The computer 100 is provided with an interface through which data to be printed, such as motion picture data corresponding to motion pictures, are transmitted to the printer 200. The motion picture providing apparatus, which is connected to the printer 200, does not necessarily have a printer driver to drive the printer 200.

Among frames that are successively input in correspondence with the motion picture data, the printer 200 extracts one or more key frames, i.e., representative frames of the motion pictures. Key frame data corresponding to the extracted key frames are converted into image data to be printed out on a printing paper or another printing medium.

The printer 200 includes an input unit 210, a display unit 220, a storage unit 230, an interface unit 240, a signal demodulator 250, an image extracting unit 260, a image processor 270, a print engine unit 280 and a controller 290.

The input unit 210 is provided with a plurality of keys to set and select various functions supported (performed) in the printer 200.

The display unit 220 displays an operational status of the printer 200 according to a control of the controller 290.

The storage unit 230 includes a non-volatile memory, such as a flash ROM, that stores various programs to support (perform) the functions of the printer 200, and a volatile memory, such as a DRAM, that stores data generated during the execution of the programs by the controller 290, which will be descried in detail later. The storage unit 230 also stores therein a plurality of image extract algorithms which are applied to the image extracting unit 260.

The interface unit 240 is provided to be connectible to the computer 100, i.e., to the motion picture providing apparatus, and supports (performs) a mutual data communication between the computer 100 and the controller 290. In addition to the motion picture data, the interface unit 240 can receive still image data and the image data, which are converted into print data to be printed on the printing paper, from the external apparatus.

The interface unit 240 supports the mutual data communication with the external devices and can be realized in the form of interface modules such as, for example, USB, IEEE 1394, Bluetooth and wireless-LAN. It is to be noted that other interface modules that can perform the required operation of the present invention may also be used as an alternative.

The signal demodulating unit 250 is controlled by the controller 290 which will be described later, and demodulates the motion picture data inputted from the interface unit 240. Since the motion picture data are large in volume, the motion picture data may be compressed before transmission. The motion picture data compression can be performed by MPEG-2 schemes. Under the control of the controller 290, the signal demodulating unit 250 de-compresses the compressed motion picture data using the corresponding decompression algorithm.

The image extracting unit 260 extracts at least one key frame, i.e., one representative frame, among the frames which are successively input in correspondence to the motion picture data which are demodulated by the signal demodulating unit 250. The ‘key frame’ refers to a single representative frame that represents several frames of certain motion picture material. In other words, the ‘key frame’ is referred to as a frame that has a special meaning among the plurality of frames of the motion picture. As the representative frames of the motion picture are extracted and displayed, the user who is viewing the extracted key frames can figure out a general content of the motion picture.

The image extracting unit 260 includes a key frame extracting unit 262 and a frame memory 264.

The key frame extracting unit 262 compares a current frame of the motion picture data, which is input from the signal demodulating unit 250, with a frame for comparison (hereinafter, referred to as “reference frame”), and calculates a comparison result. For example, the key frame extracting unit 262 compares a first motion vector with respect to the current frame with a second motion vector with respect to the reference frame, and calculates a difference between the first and second motion vectors. The key frame extracting unit 262 having the calculated difference then compares the calculated difference with a predetermined threshold value. If the comparison result is greater than the predetermined threshold value, the key frame extracting unit 262 extracts the current frame and stores it in the frame memory 264 as the key frame.

If the calculated comparison result is equal to or smaller than the predetermined threshold value, the key frame extracting unit 262 sets the current frame as the reference frame while setting a next frame as the current frame. Accordingly, the key frame extracting unit 262 compares the current frame, which is the next frame of the current frame, with the reference frame which is the set current frame. The above process is repeated until a last frame of the motion picture data is inputted.

The reference frame may be a preceding frame before the current frame, or a preceding key frame. Accordingly, the key frame extracting unit 262 may calculate the comparison result by comparing the current frame with the preceding frame or alternatively, by comparing the current frame with the preceding key frame.

The image extracting unit 260 may output to the controller 290 a signal that indicates a key frame extracting result whenever the key frame is extracted by the key frame extracting unit 262. Alternatively, the image extracting unit 260 may output the signal that indicates the key frame extracting result when the above-described key frame extracting operation is completed with respect to the inputted motion picture data.

When there is a certain preset number of frames to be outputted as the key frames, or when the user wants to set a certain desired number of frames to be outputted as the key frames, the image extracting unit 260 may re-extract one or more sub-key frames from the key frames to be outputted to the print engine unit 280 through the image processor 270 according to the preset or desired number of frames under the control of the controller 290. The number of the sub-key frames is equal to or less then the number of the key frames.

In this embodiment, the key frames are extracted based on the motion vector difference between the current frame and the preceding frame by way of an example. However, the invention is not limited thereto. For example, the key frames can be extracted using various key frame extracting algorithms, such as a brightness difference between pixels, brightness information of regions where the respective pixels belong to, and a brightness histogram of the entire frames where the respective pixels belong to.

The frame memory 264 stores the preceding frame and/or at least one key frame that is extracted by the key frame extracting unit 262.

The image processor 270 converts key frame data corresponding to the at least one key frame output from the image extracting unit 260 into image data that can be printed in the print engine unit 280.

The image processor 270 performs color matching so that a color signal of the motion picture data transmitted from the computer 100 can match a color representation range of the print engine unit 280. This is because, generally, the color signal transmitted from the computer 100 is an RGB (red, green, blue) color signal while a color signal from the print engine unit 280 is a YMCK (yellow, magenta, cyan, black) color signal. Accordingly, in a color matching process required in the image processor 270, a color gamut of the RGB color signal of the computer 100 is changed (converted) to match a color gamut of the YMCK color signal used in the print engine unit 280.

Based on the principle of complementary color, the image processor 270 performs halftoning after the color conversion to the YMCK color signal from the RGB color signal, thereby converting the key frame data into the image data that can be printed in the print engine unit 280. The color matching, the color conversion and the halftoning by the image processor 270 are generally-known, and thus, a detailed description thereof will be omitted.

As power is applied to the printer 200, the controller 290 controls an overall operation of the printer 200 in accordance with control programs stored in the storage unit 230.

The controller 290 determines whether the data received from the computer 100, which is connected to the controller 290 of the printer 200 through the interface unit 240, is the motion picture data. The controller 290 checks information contained in a frame header of the data, which is received through the interface unit 240, to determine if the currently received data is the motion picture data. The frame header of the data contains information such as a data type and/or a data compression type.

Upon determining that the data received through the interface unit 240 is the motion picture data, the controller 290 controls the signal demodulating unit 250 to recover (restore) the motion picture data which are in a predetermined compression format. After being demodulated by the signal demodulating unit 250, the motion picture data is output to the image extracting unit 260 in a frame unit.

The controller 290 also controls the image extracting unit 260 to extract the key frames representing the motion pictures among the frames demodulated by the signal demodulating unit 250. The controller 290 selects one of the image extracting algorithms stored in the storage unit 230, provides the image extracting unit 260 with the selected image extracting algorithm, and controls the image extracting unit 260 to extract the key frames using the selected image extracting algorithm.

Alternatively, the key frames may be extracted by a default image extracting module among a plurality of image extracting modules. In this case, when there is a change in the image extracting algorithm according to an image algorithm selection request signal inputted from the user through the input unit 210, the key frames can be extracted by the changed image extracting algorithm.

When a signal about the key frame extracting result is received from the image extracting unit 260, the controller 290 controls the image processor 270 to convert the key frame data extracted by the image extracting unit 260 into the image data that can be printed in the print engine unit 280.

The controller 290 then transmits the image data from the image processor 270 to the print engine unit 280 and controls the print engine unit 280 to perform a printing operation with respect to the image data.

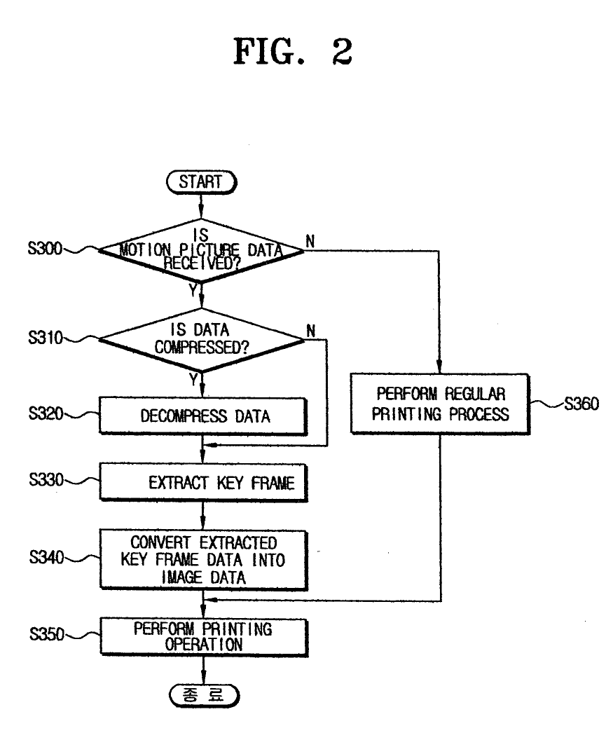

Hereinbelow, a printer control method according to another embodiment, and performed in the image printing system illustrated in FIG. 1, will be described with reference to FIG. 2.

When the data to be printed is received from the computer 100 which is connected via the interface unit 240, the controller 290 determines whether the received data is the motion picture data in operation S300. If it is determined in operation S300 that the motion picture data is received, the controller 290 determines whether the received motion picture data is compressed data in operation S310.

If it is determined in operation S310 that the motion picture data is compressed data, the controller 290 controls so that the compressed data can be de-compressed by a de-compression algorithm corresponding to the compression algorithm, by which the motion picture data was compressed, in operation S320. According to the control of the controller 290, the signal demodulating unit 250 demodulates the de-compressed motion picture data. Meanwhile, if it is determined in operation S310 that the motion picture data is non-compressed data, the controller 290 skips the operation S320 and performs the operation S330.

When the motion picture data is demodulated by the signal demodulating unit 250, the controller 290 controls the image extracting unit 260 to extract at least one key frame representing the motion picture data among the frames being successively input from the signal modulating unit 250 in correspondence with the motion picture data in operation S330.

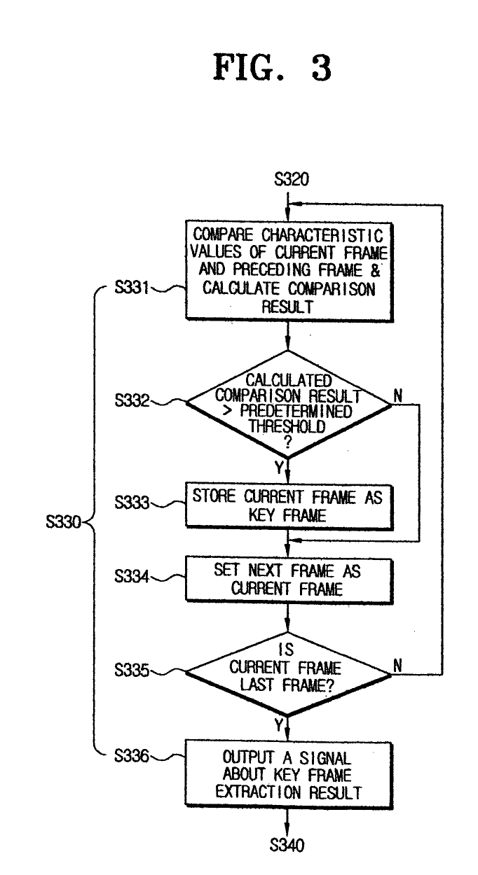

With reference to FIG. 3, a key frame extracting process performed in operation S330 will be described in greater detail. First, the key frame extracting unit 262 compares a characteristic value of the current frame input from the signal demodulating unit 250 with that of the preceding frame and calculates the comparison result in operation S331. The key frame extracting unit 262 then compares the calculated comparison result with the predetermined threshold value and determines whether the comparison result is greater than the predetermined threshold value in operation S332.

If it is determined in operation S332 that the comparison result is greater than the predetermined threshold value, the key frame extracting unit 262 extracts the current frame as the key frame in operation S333. Then the next frame is set as the current frame in operation S334. Meanwhile, if it is determined in operation S332 that the comparison result is equal to or smaller than the predetermined threshold value, the key frame extracting unit 262 performs the operation S334.

The key frame extracting unit 262 determines whether the current frame is the last frame in operation S335. If it is determined in operation S335 that the current frame is the last frame, the key frame extracting unit 262 outputs to the controller 290 the signal about key frame extraction result in operation S336. The key frame extracting unit 262 may output the signal about key frame extraction result every time the key frame is extracted. If it is determined that the current frame is not the last frame, the key frame extracting unit 262 returns to the operation S331 to repeat the operations S332-S334 until the operation S335 determines that the current frame is the last frame.

When the at least one key frame is extracted and the signal about the key frame extraction result is received in operation S330, the controller 290 controls the image processor 270 to convert the extracted key frame data into the image data that can be printed in the print engine unit 280 in operation S340.

When the key frame data is converted into the image data by the image processor 270, the controller 290 controls the print engine unit 280 to perform the printing operation with respect to the image data in operation S350. The print engine unit 280 prints the image data input from the image processor 270 onto the printing paper in accordance with the control of the controller 290.

Meanwhile, if it is determined in operation S300 that the data received through the interface unit 240 is non-motion picture data, the printer 200 performs a regular printing operation in operation S360. For example, the printer 200 prints the still picture data or text data in the same way as a general printer does. Accordingly, description about the regular printing operation will be omitted.

As described above, in the printer having the motion picture data output function and the control method thereof according to the embodiment of the present invention, with the provision of the image extracting module that can extract the key frame representing the motion picture data, the externally-received motion picture data can be easily output onto the printing paper or another printing medium. Further, since the printer itself converts the externally-received motion picture data into printable data, the printer can be connected with the motion picture providing apparatus that is not provided with the printer driver, such as the digital video camera, the PDA or the cellular phone. In conclusion, with the printer according to the present invention, any motion picture data, i.e., movies or animations, that are captured through the photographing device or obtained through the Internet, can be easily output onto the printing paper or another printing medium.

Although a few embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A printer to output motion picture data, comprising:
an interface unit connectable with an external device to receive frames that are successively input from the external device according to the motion picture data;
an image extracting unit to extract at least one key frame from the frames input through the interface unit, the key frame representing the motion picture data; and
a controller to control the image extracting unit to extract the at least one key frame to represent the motion picture data upon determining that the motion picture data is received through the interface unit.

2. The printer of claim 1, further comprising:
a print engine unit to print data; and
an image processor to convert key frame data corresponding to the key frame extracted by the image extracting unit into image data that can be printed in the print engine unit.

3. The printer of claim 1, wherein the image extracting unit compares a current frame that is input through the interface unit with a reference frame, calculates a comparison result, compares the comparison result with a predetermined threshold value, and extracts the current frame as the key frame that represents the motion picture data when the comparison result is greater than the predetermined threshold value.

4. The printer of claim 3, wherein the reference frame is one of a preceding frame of the current frame and a preceding key frame that is extracted previously.

5. A control method used with a printer outputting motion picture data, the printer connected with an external device through an interface unit to print out the motion picture data input from the external device, the control method comprising:
receiving data to be printed from the external device through the interface unit;
determining whether the data received through the interface unit is the motion picture data;
extracting a key frame from frames that are successively input according to the motion picture data upon determining that the data is the motion picture data, the key frame that represents the motion picture data;
converting key frame data corresponding to the extracted key frame into image data; and
printing out the converted image data on a printing paper.

6. The control method of claim 5, wherein the extracting of the key frame comprises:
comparing a current frame of the motion picture data that is input through the interface unit with a reference frame to calculate a comparison result; and
comparing the comparison result with a predetermined threshold value to extract the current frame as the key frame that represents the motion picture data when the comparison result is greater than the predetermined threshold value.

7. The control method of claim 6, wherein the reference frame is one of a preceding frame of the current frame and a preceding key frame that is extracted previously.

8. A printer comprising:
an interface unit connectable to an external device to receive motion picture data having frames from the external device; and
an image extracting unit to extract one or more key frames from the frames according to a difference between the frames, the one or more key frames representing the frames of the motion picture data so that data corresponding to the one or more key frames are printed.

9. The printer of claim 8, further comprising:
a printer engine unit to print the data on a printing paper.

10. The printer of claim 8, further comprising:
an input unit through which a signal corresponding to the number of the one or more key frames is inputted to the image extracting unit, wherein the image extracting unit extracts the one or more key frames according to the signal.

11. The printer of claim 8, wherein the image extracting unit extracts a predetermined number of the one or more key frames from the frames, and the predetermined number is equal to or less than the number of the frames.

12. The printer of claim 11, wherein the predetermined number of the one or more key frames and the number of the frames are constant.

13. The printer of claim 11, wherein the predetermined number of the one or more key frames and the number of the frames are variable.

14. The printer of claim 11, wherein the predetermined number is set before the motion picture data is inputted to the interface unit.

15. The printer of claim 11, wherein the image extracting unit re-extracts a number of sub-key frames from the predetermined number of the one or more key frames to be printed.

16. The printer of claim 15, wherein the number of the sub-key frames and the number of the one or more key frames are constant.

17. The number of claim 15, wherein the number of the sub-key frames and the predetermined number of the one or more key frames are variable.

18. The printer of claim 15, wherein one of the number of the sub-key frames and the predetermined number of the one or more key frames is constant, and the other one of the number of the sub-key frames and the predetermined number of the one or more key frames is variable.

19. The printer of claim 8, further comprising:
a signal demodulating unit decompressing the motion picture data when the motion picture data is a compressed format, and transmitting the de-compressed motion picture data to the image extracting unit in a frame unit to form the frames.

20. The printer of claim 19, further comprising:
a processor to convert the data corresponding to the one or more key frames into image data; and
a print engine unit printing the image data.

21. The printer of claim 20, wherein the data is an RGB color signal, and the image data in a YMCK color signal.

22. The printer of claim 8, further comprising:
a display unit displaying an image corresponding to respectively ones of the one or more key frames.

23. The printer of claim 8, further comprising:
a memory unit storing the one or more key frames.

24. The printer of claim 8, further comprising:
a controller controlling the image extracting unit to extract the one or more key frames from the frames according to the difference representing one of a first change between pixels of the frames, a second change between predetermined regions of the frames, and a third change between the frames.

25. The printer of claim 24, wherein each of the frames includes frame information representing at least one of a brightness and a motion vector, and the first, second and third changes are a change between the frame information of the frames.

26. The printer of claim 8, further comprising:
a controller controlling the image extracting unit to extract the one or more key frames from the frames according to the difference representing a change between brightness histograms corresponding to the respective frames.

27. The printer of claim 8, further comprising:
a controller controlling the image extracting unit to extract the one or more key frames from the frames according to the difference representing a change between frame header information of the frames.

28. The printer of claim 8, further comprising:
a controller controlling the image extracting unit to extract the one or more key frames from the frames of the moving picture data according to the difference representing a change from a first image extracting module to a second image extracting module wherein the first and second image extracting modules are used to extract to at least one key frame from the frames of the moving picture data.

29. A method used with a printer, the method comprising:
receiving motion picture data having frames from an external device connectable to the printer; and
extracting one or more key frames from the frames of the moving picture data according to a difference between the frames so that data corresponding to the one or more key frames is printed.
